(19) United States
(12) Patent Application Publication
(10) Pub. No.: US 2023/0312954 A1
(43) Pub. Date: Oct. 5, 2023

(54) PEELABLE WRITING INK COMPOSITION WITH COLOR-CHANGING FOR WRITING POROUS SUBSTRATES

(71) Applicant: SOCIÉTÉ BIC, Clichy Cedex (FR)

(72) Inventor: Carine BETHOUART, Clichy Cedex (FR)

(73) Assignee: SOCIÉTÉ BIC, Clichy Cedex (FR)

(21) Appl. No.: 18/043,245

(22) PCT Filed: Aug. 30, 2021
(86) PCT No.: PCT/EP2021/073906

§ 371 Date: Feb. 27, 2023

(30) Foreign Application Priority Data
Aug. 31, 2020 (EP) 20305964.7

(51) Int. Cl. C09D 11/17; C09D 175/04

(52) U.S. Cl. CPC C09D 11/17; C09D 175/04

(57) ABSTRACT

The present disclosure concerns a writing ink composition comprising:
(a) at least one film-forming elastomeric polymer wherein the film-forming elastomeric polymer (a) is an homopolymer or copolymer of polyurethane,
(b) at least one polyether-modified polysiloxane,
(c) at least one dye,
(d) at least one pigment, and
(e) water.

The disclosure also concerns a method for preparing such a writing ink composition. A writing instrument comprising such a writing ink composition, and a method for writing on a writing porous substrate, are also part of the disclosure. Finally, the disclosure aims at a writing porous substrate coated with a writing ink composition according to the disclosure.

### CROSS REFERENCE TO RELATED APPLICATIONS

This application is a National Stage Application of International Application No. PCT/EP2021/073906, filed on Aug. 30, 2021, now published as WO2022/043560 and which claims priority to European Application No. 20305964.7, filed on Aug. 31, 2020, the entire contents of which is incorporated herein by reference.

### TECHNICAL FIELD

The present disclosure concerns a writing ink composition, in particular allowing color-changing, more specifically an aqueous peelable writing ink composition with color-changing, in particular for writing porous substrates such as paper, printer paper or cardboard. The disclosure also concerns a method for preparing such a writing ink composition. A writing instrument comprising such a writing ink composition and a method for writing on a writing porous substrate are also part of the disclosure. Finally, the disclosure concerns a writing porous substrate coated with a writing ink composition according to the disclosure.

The writing ink composition of the disclosure includes at least one film-forming elastomeric polymer wherein the film-forming elastomeric polymer is an homopolymer or copolymer of polyurethane, at least one polyether-modified polysiloxane, as well as dye and pigment dispersed in water. When the writing ink composition is applied to porous substrates, the water evaporates and the polymer provides a coalesced residue on the surface of the substrate. The writing ink composition is more specifically peelable in that the residue can be removed from the surface of the substrate, more specifically paper surface, for some period of time after formation without leaving a residue or damaging the substrate. Hence, the initial color (first color) of the writing ink composition after writing on a substrate can be removed by peeling, and the written mark changes into a second color. More specifically, the first and second colors are different which means that they can be distinguished from each other by the human eye. The writing ink composition of the disclosure is particularly suitable for use with writing porous substrates (also named porous surfaces) made, basically, of pressed, matted fibers, like paper, printer paper or cardboard, in particular writing fibrous substrates (also named fibrous surfaces). The writing ink composition of the disclosure is also storage-stable, easy to manufacture, and easy to apply.

The writing ink composition of the disclosure more specifically has a low viscosity, more specifically a viscosity ranging from 3 to 10 mPa·s, even more specifically ranging from 3 to 7 mPa·s, (the viscosity being measured at 20° C. with a Shell Cup #1 marketed by NORCROSS® Corporation) and as a result is particularly suitable for use with standard felt-tip markers that rely on a capillary feed system to draw ink from a reservoir. Thus, the writing ink composition of the disclosure is suitable for use in felt-pens, highlighters, markers, which typically use colored pigments. When the viscosity is less than 3 mPa·s, the pigment particles may settle more rapidly in the writing ink composition with a risk of ink leakage. Furthermore, when the viscosity is higher than 10 mPa·s, the flow rate of the writing ink composition is too low and any line was not written.

Furthermore, the writing ink composition of the disclosure can be included in one single writing instrument. This allows having multiple color options within the same color mark, for example when the user takes notes, journal or draws to emphasize information or to make things stand out, which allows the user not to use multiple writing instruments.

### BACKGROUND

Color-changing writing ink compositions capable of changing the color of the ink by an eraser are known in the art such as in EP2977416. The color-changing ink compositions contain a water-soluble resin, as well as pigment and dye. However, with this kind of color-changing ink compositions, peelability may be difficult after a long period of time, and is thus sometimes not satisfactory. Furthermore, the peelability of the ink compositions of the prior art requires significantly high pressure to obtain a good color-changing. In addition, the colors obtained with the ink compositions of the prior art are generally not very vivid.

EP20167374.6 also discloses a color-changing ink composition capable of changing the color of the ink by an eraser. The ink composition described contains acrylonitrile butadiene rubber (NBR) and/or hydrogenated acrylonitrile butadiene rubber (HNBR) as the film-forming agent and polyoxyethylene sorbitan ester. However surprisingly the inventors have found that the use of polyether-modified polysiloxane such as Bis-PEG 15-Methyl Ether Dimethicone (INCI name) in particular sold under the tradename Belsil® DMC 6038 by Wacker improves the quality of erasing and acts as a release agent. There are indeed less traces after erasing after its introduction in the composition when compared to the composition of the prior art.

JP2002265843 describes a color changeable writing ink composition comprising an urethan resin, a pigment, a dye and water. It is mentioned in this document, that it is possible to add a silicone-based surfactant to improve the ink penetration. Hence, the skilled person in the art is encouraged to use a silicone raw material in order to facilitate the penetration of the ink into porous substrates. In contrary, according to the disclosure, polyether modified polysiloxane is used as release agent. That means that polyether modified polysiloxane migrates to the surface on the porous substrate and decreases the adhesion of the ink composition on porous substrate.

Therefore, there is a need to find a new color-changing writing ink composition enabling to obtain a good deposit which has, in particular, a satisfactory color intensity (vivid), a good color-changing capacity (in particular such as easiness and efficiency of the color-changing) particularly when used on writing porous substrates, more specifically while avoiding an unwanted color return and/or color change or color loss due to a change in temperature.

### SUMMARY

The inventors have surprisingly found that the use of a polyether-modified polysiloxane, in combination with an homopolymer or copolymer of polyurethane, in presence of pigment and dye dispersed in water, can lead to a writing color-changing ink composition resolving the above-mentioned problems. The writing ink composition of the disclosure also presents the advantage of being peelable, for example with fingers, in particular by applying a low pressure (by the user), thus using less waste than with conventional erasers. Furthermore, the writing ink composition of the disclosure also presents the advantage of enabling a change of color. In particular, the deposit made with the writing ink composition on writing porous substrate can be easily and/or efficiently removed (peeled or rubbed), in particular the deposit can be easily removed when an intentional friction force is applied (in particular the deposit is not unintentionally removed).

In addition, the writing ink composition of the disclosure enables obtaining vivid colors of written marks once applied, especially on writing porous substrates, in particular the initial first color as well as the second color (after peeling) are vivid.

An additional advantage of the disclosure is the possibility to obtain a writing ink composition with color-changing having a good cap-off time. The term “cap-off” designated the ability of the writing ink composition of the disclosure with color-changing of not drying up in the writing instrument, which means in particular that the writing instrument can be left open for longer period of time, more specifically one hour or even several hours, in particular with removed cap, without drying up.

The present disclosure therefore concerns a writing ink composition comprising:
(a) at least one film-forming elastomeric polymer wherein the film-forming elastomeric polymer (a) is an homopolymer or copolymer of polyurethane,
(b) at least one polyether-modified polysiloxane,
(c) at least one dye,
(d) at least one pigment, and
(e) water.

### DETAILED DESCRIPTION

Hereinafter, a detailed description of the present disclosure will be given. The specific embodiments are meant to better illustrate the present disclosure, however, it should be understood that the present disclosure is not limited to these specific embodiments.

In the sense of the present disclosure, the expression “comprising a” should be understood as being synonymous with “comprising at least one”.

In the sense of the present disclosure, the expressions “between . . . and . . . ” or “ranging from . . . to . . . ” should be understood as including the values of the limits.

The writing ink composition according to the present disclosure is more specifically a color changing writing ink.

For the purposes of the present disclosure, the term “color-changing writing ink” is intended to mean any writing ink which can change color after writing.

After writing, in particular on a writing substrate, the written mark made with the ink can change from a first initial color to second color. In particular, the term “color-changing writing ink” is intended to mean that the initial first color of the writing ink is changed into another (second) color. In particular, this second color is not colorless (in this sense, the writing ink according to this disclosure is not erasable). Hence, the initial color (first color) of the writing ink composition after writing on a substrate can be changed into a second color by removing part of the written mark, in particular by peeling (or rubbing). In particular, the first and second colors are different which mean that they can distinguished from each other by human eye.

The first (initial) color of the written mark before the color change will depend on the color of the dye(s) and pigment(s) contained in the writing ink com position.

By peeling the written mark, the pigment(s) is(are) removed, and therefore after peeling, the second color of the written mark will depend on the dye(s) comprised in the writing ink composition. Therefore, part of the written mark (deposit) has been removed.

The written mark obtained, in particular on cellulosic fiber paper such as paper (printer paper for example) and cardboard paper, by this writing ink can therefore change color just after writing and also even a few days after writing.

The writing ink composition according to the present disclosure is more specifically a peelable writing ink.

For the purposes of the present disclosure, the term “peelable” writing ink is intended to mean that the written mark made with the writing ink can be peeled (or rubbed) after writing by removing part of the written mark, such as by mechanical friction, more specifically by the use of a finger or a friction body wherein the friction body can be an eraser or a tissue. For example, the eraser can be a rubber which can be made of a blend of ethylene-propylene-diene monomer rubber and polypropylene. In particular, the writing ink can be peeled (or at least partly peeled) from a writing substrate, in particular for some period of time after formation of the writing mark, without damaging the substrate. The written mark obtained, in particular on cellulosic fibers papers, by this writing ink can therefore be peeled just after writing such as less than 10 second after writing, even a few days after writing, and also even one month after writing, to change the initial (ie first) color of the writing mark in another color (second color).

More specifically, the present disclosure concerns a peelable color-changing writing ink comprising: (a) at least one film forming elastomeric polymer wherein the film-forming elastomeric polymer (a) is an homopolymer or copolymer of polyurethane, (b) at least one polyether-modified polysiloxane, (c) at least one dye, (d) at least one pigment, and (e) water, wherein the color changing , in particular from a first color into a second color; is essentially obtained by removing the pigment by peeling.

Hence, once applied, the first color of the written mark made with the writing ink composition according to the disclosure, can be changed by peeling off the written mark into a second color.

The writing ink composition according to the present disclosure is more specifically irreversibly peeled. It is therefore an irreversible peelable color-changing writing ink composition. More specifically, once the color has changed, it is not possible to change it again, and in particular it is not possible to go back to the initial color (first color).

The writing ink according to the present disclosure is a non-thermochromic ink.

For the purposes of the present disclosure, the term “non-thermochromic ink” is intended to mean any ink which will not be erased or will not change its color due to a change in temperature such as an increase or a decrease. For the purposes of the present disclosure, the term “writing porous substrate” is intended to mean writing substrate that contains pores. The writing porous substrates have empty spaces or pores that allow external matter, like writing ink, to penetrate into the substrate. In particular, writing surfaces such as white board or enamel board are not considered as writing porous substrate. In particular, the writing porous substrates are fibrous. In particular, the “writing porous substrate” can be cellulosic fiber paper such as paper (printer paper for example) and cardboard paper. More specifically, the average size of the pores of writing porous substrate ranges from 1 nanometer to 10 micrometers, in particular when measured by inverse size-exclusion chromatography.

More specifically, the roughness of the writing substrate can be defined by its air permeability and measured by the standard ISO 8791-2:2013 (unit: mL.min⁻¹). In a preferred embodiment, the air permeability of the writing porous substrate of the disclosure ranges from 50 to 1,000 mL.min⁻¹, more specifically from 60 to 400 mL.min⁻¹, and even more specifically from 80 to 280 mL.min⁻¹.

In particular, the writing porous substrate is chosen among writing porous substrate comprising cellulosic fibers such as paper, printer paper, or cardboard.

The writing ink composition according to the present disclosure is more specifically an aqueous writing ink. For the purposes of the present disclosure, the term “writing ink” is intended to mean any ink which is intended to be used in a writing instrument, and in particular in a felt-pen, a highlighter, a marker. A writing ink should not be confused with a printing ink which is used in printing machines and which does not have the same technical constraints, and thus the same specifications. Indeed, a writing ink must not contain solid particles of which the size is greater than the channels of the writing instrument, in order to avoid blocking them, which would inevitably lead to writing being irreversibly stopped. It must also dry sufficiently rapidly to avoid smudging the writing medium. It must also avoid the problems of migration (bleeding) over time. Thus, the writing ink composition according to the present disclosure will be suitable for the writing instrument for which it is intended, in particular for handheld writing instrument.

In the sense of the disclosure, “film-forming” means a polymer capable of forming, by itself a macroscopically continuous film on a writing substrate, in particular on a writing porous substrate, and more specifically a cohesive film.

In the sense of the disclosure, “elastomeric” means a polymer that displays rubber-like elasticity, i.e. a deformable, flexible polymer which has viscoelastic properties.

In the sense of the disclosure, a “polymer” is a compound (in particular a large molecule or a macromolecule) corresponding to the repetition of one or more units (these units being derived from compounds called monomers), and in particular the repetition of at least two repeating units, and more specifically at least ten repeating units.

The film-forming elastomeric polymer (a) allows the fixation of the writing ink composition of the disclosure on the paper, and therefore avoids the written mark (deposit) of the writing ink to be peeled (i.e. removed) by simply brushing it with another sheet of paper while being able to change its initial first color to another one by peeling with a finger or a friction body. The at least one film-forming elastomeric polymer (a) of the disclosure is an homopolymer or copolymer of polyurethane, more specifically selected in the group consisting of amphoteric polyurethanes, anionic polyurethanes, cationic polyurethanes, non-ionic polyurethanes, polyester-polyurethanes, polyether-polyurethanes and mixtures thereof, more specifically the polyurethane (a) is an anionic polyurethane homopolymer or copolymer, even more specifically the polyurethane (a) is an anionic polyurethane homopolymer, in particular the polyurethane (a) is an aliphatic polyurethane. More particularly it can be a polyester-polyurethane such as an anionic aliphatic polyester-polyurethane for example commercially available under the name Impranil® DLE, Impranil® DL1069 or Bahydrol® UH240 (Covestro AG), a polyether diol polyurethane such as an anionic aliphatic polyurethane based on polyester diols for example commercially available under the name Esacote PU78 (Lamberti) or an anionic aliphatic polyurethane for example commercially available under the name Esacote SW3 (Lamberti). More specifically, the polyurethane (a) is a polyether diol polyurethane such as an anionic aliphatic polyurethane based on polyester diols for example commercially available under the name Esacote PU78 (Lamberti) or an aliphatic polyurethane for example commercially available under the name Esacote SW3 (Lamberti), still more specifically it is an aliphatic polyurethane for example commercially available under the name Esacote SW3 (Lamberti).

In an advantageous manner, the polyurethane (a) is in the form of an aqueous dispersion.

More specifically, the writing ink composition of the disclosure does not comprise a water-soluble resin. More specifically, the writing ink composition of the disclosure, does not comprise a water-soluble resin and the polyurethane (a) is in the form of an aqueous dispersion.

In an advantageous manner, the film-forming elastomeric polymer (a) is not in the form of spherical particles such as beads, more specifically the homopolymer or copolymer of polyurethane (a) is not in the form of spherical particles such as beads.

More specifically, the total solid content of the polyurethane (a) ranges from 8 to 25%, more specifically from 10 to 20%, by weight relative to the total weight of the writing ink composition.

The writing ink composition of the disclosure also comprises at least one polyether-modified polysiloxane.

In the sense of the present disclosure the term “polyether-modified polysiloxane” is intended to mean any polysiloxane, in particular any alkylpolysiloxane, more particularly any poly((C₁-C₆)alkyl)siloxane, which is modified by a polyether, more specifically a poly ((C₁-C₆)alkyloxy. More specifically, the polyether-modified polysiloxane is a polyalkyloxy-polysiloxane.

In an advantageous manner, the polyether-modified polysiloxane (b) is non-ionic, more specifically it is water soluble or dispersible in water. In an advantageous manner, the polyether-modified polysiloxane (b) is a polyether-modified poly((C₁-C₆)alkyl)siloxane, in particular a polyalkyloxy-poly((C₁-C₆)alkyl)siloxane, in particular a polyether-modified polydimethylsiloxane, more specifically a poly((C₁-C₆)alkyloxy polydimethylsiloxane, more particularly a polyoxyethylenated polydimethylsiloxane, and in a particular manner it is a Bis-PEG 15-Methyl Ether Dimethicone (INCI name), in particular having the following formula (1):

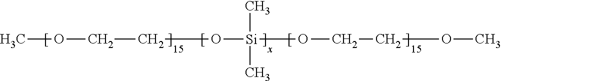

for example commercially available under the name BELSIL® DMC 6038 (Wacker).

More specifically, the total amount of the at least one polyether-modified polysiloxane (b) in the writing ink composition of the disclosure ranges from 0.5 to 5% by weight, more specifically from 1 to 4% by weight, relative to the total weight of the writing ink composition.

The writing ink composition of the disclosure also comprises at least one dye (c), in particular a mixture of dyes, solubilized in water. The term “dyes” should be understood as meaning colored, mineral or organic particles of any form, which are soluble in the medium in which they are solubilized, and which are intended to color the writing ink composition once applied on a writing porous substrate after peeling. Thanks to the presence of a dye in the writing ink composition of the disclosure, the initial (first) color of the writing mark can change in another color (second color) by peeling with a finger or a friction body. The at least one dye (c) may be selected in the group consisting of direct dyes (for example C.I direct black 17, 19, 22, 32, 38, 51, 71; C.I direct yellow 4, 26, 44, 50; C.I direct red 1, 4, 23, 31, 37, 39, 75, 80, 81, 83, 225, 226, 227; C. direct blue 1, 15, 41, 71, 86, 87, 106, 108, 199, and the like), acid dyes (for example C.I acid black 1, 2, 24, 26, 31, 52, 107, 109, 110, 119, 154; C.I acid yellow 1, 7, 17, 19, 23, 25, 29, 38, 42, 49, 61, 72, 78, 110, 127, 135, 141, 142; C.I acid red 8, 9, 14, 18, 26, 27, 33, 35, 37, 51, 52, 57, 82, 83, 87, 92, 94, 111, 129, 131, 138, 186, 249, 254, 265, 276; C.I acid violet 15, 17, 49; C.I acid blue 1, 3, 7, 9, 15, 22, 23, 25, 40, 41, 43, 62, 78, 83, 90, 93, 100, 103, 104, 112, 113, 158; C.I acid green 3, 9, 16, 25, 27; C.I acid orange 56, and the like), food dyes (such as C.I. food yellow 3, and the like), Malachite green (C.I 4200) Victoria blue FB (C.I. 44045) methyl violet FN (C.I. 42535), rhodamine F4G (C.I. 45160), and rhodamine 6GCP (C.I 45160), and mixtures thereof.

The content of the at least one dye (c) in the writing ink composition according to the disclosure may range from 0.1 to 10% by weight, more specifically from 0.2 to 8% by weight, and more specifically from 0.3 to 5% by weight, by weight relative to the total weight of the writing ink composition.

The writing ink composition of the present disclosure also comprises at least one pigment (d). The term “pigment” should be understood as meaning white or colored, mineral or organic particles of any form, which are insoluble in the medium in which they are solubilized, and which are intended to color the writing ink composition once applied on a writing porous substrate before peeling. The pigments (d) are also generally contained in a dispersion, where the grinding down or particle size reduction is accompanied by appropriate dispersants to achieve stable dispersions. The at least one pigment (d) is more specifically in the form of a pigment dispersion, even more specifically selected in the group consisting of pigment black 7 (such as Flexiverse III black 7 by SunChemical®), pigment blue 15:3 (such as APE FREE BL 15:3 DISP by SunChemical®), pigment red 210 (such as Sunsperse®Red 210by SunChemical®), pigment green 7 (such as Sunsperse Eco green, Flexiverse FD Green, Flexiverse Green 7, Flexiverse HC GRN 7 by SunChemical®), and mixtures thereof. In a preferred embodiment, the at least one pigment (b) is selected in the group consisting of pigment black 7 (such as Flexiverse III black 7 by SunChemical®), pigment blue 15:3 (such as APE FREE BL 15:3 DISP by SunChemical®), and mixtures thereof.

According to a preferred embodiment, the diameter of the pigment in the pigment dispersion is less than 1 μm, and more specifically less than 0.7 μm.

More specifically, the total amount of pigment (d) ranges from 30 to 60% by weight, relative to the total weight of the pigment dispersion.

More specifically, the total amount of pigment (d) in the writing ink composition according to the disclosure ranges from 0.1 to 10% by weight, and more specifically from 0.5 to 7% by weight, relative to the total weight of the writing ink composition.

The writing ink composition of the disclosure also contains water (e) as the solvent.

More specifically, the total amount of water (e) in the writing ink composition of the disclosure ranges from 10 to 80% by weight, more specifically from 20 to 80% by weight, and even more specifically from 40 to 80% by weight, relative to the total weight of the writing ink composition.

More specifically, the total amount of water (e) in the writing ink composition of the disclosure ranges from 10 to 80% by weight, more specifically from 10 to 70% by weight, and in particular from 20 to 60% by weight, relative to the total weight of the writing ink composition.

More specifically, writing ink composition of the disclosure are water-based inks compositions. More specifically, water (e) is the main solvent of the writing ink composition of the disclosure.

The writing ink composition of the disclosure may further contain at least one plasticizer. The plasticizer of the disclosure is chosen in the group consisting of alcohols, more specifically glycerin, benzoate esters, diisobutyrate esters such as trimethyl pentanyl diisobutyrate, and mixtures thereof, and even more specifically glycerin, benzoate esters, and mixtures thereof, in particular glycerin. According to a preferred embodiment, the writing ink composition of the disclosure comprises as plasticizer a mixture of at least one ester and at least one alcohol, wherein the at least one alcohol more specifically has a boiling point higher than 160° C., and even more specifically is glycerin (boiling point: 290° C.).

More specifically, the content of plasticizer in the writing ink composition of the disclosure ranges from 1 to 25% by weight, and more specifically from 7 to 20% by weight, relative to the total weight of the writing ink composition. The writing ink composition according to the present disclosure may further comprise additional additive(s) known by the skilled person to be usable in writing ink compositions, in particular in aqueous writing ink compositions, more specifically selected in the group consisting of antimicrobial agents, antifungal agents, dispersing agents, wetting agents, pH regulators, and mixtures thereof.

More specifically, the content of additional additive(s) in the writing ink composition of the disclosure ranges from 0.1 to 30% by weight, even more specifically from 0.1 to 20% by weight, and even more specifically from 0.1 to 10% by weight, relative to the total weight of the writing ink composition.

The writing ink composition of the disclosure may more specifically contain at least one antimicrobial agent such as methyl paraben, phenoxyethanol, isothiazolinone, 1,2-benzoisothiazolin-3-one, 2-methyl-4-isothiazolin-3-one, and mixtures thereof.

More specifically, the antimicrobial agent is present in the writing ink composition of the disclosure in a content ranging from 0.1 to 5% by weight, and even more specifically from 0.1 to 2% by weight, relative to the total weight of the writing ink composition.

The writing ink composition according to the present disclosure may also contain a pH regulator, more specifically chosen in the group consisting of ammonia, urea, monoethanolamine, diethanolamine, triethanolamine, alkali metal salts of phosphoric acid such as tripolyphosphate, sodium carbonate and hydroxides of alkali metals such as sodium hydroxide.

The writing ink composition according to the present disclosure is more specifically peelable, even more specifically it is a peelable color-changing writing ink, still more specifically the writing ink composition is changing from a first initial color in a second color by peeling, in particular by peeling such as by mechanical friction, more particularly by the use of a finger or a friction body wherein the friction body is an eraser or a tissue, in particular an eraser. The writing ink composition of the disclosure is therefore not peelable or color-changing by the use of the heat generated by the friction of the finger or the eraser.

More specifically, the eraser used as a friction body may be chosen in the group consisting of ethylene-propylene-diene monomer (EPDM) rubber, Vulcanized Thermoplastic Elastomer (TPV) which is a blend of ethylene-propylene-diene monomer (EPDM) rubber and polypropylene (PP), ethylene-propylene rubber (EPR), poly(styrene-butadiene-styrene) (SBS), styrene ethylene butylene styrene (SEBS), natural rubber (NR), polyisoprene (IR), polyvinyl chloride, styrene-based thermoplastic elastomers including styrene-butadiene-styrene (SBS), styrene-ethylene-butylene-styrene (SEBS), styrene-ethylene-propylene-styrene (SEPS), styrene-ethylene-ethylene-propylene-styrene (SEEPS), polyether based polyurethane (PTU) , and mixtures thereof.

More specifically, the tissue used as a friction body may be chosen in the group consisting of cotton fabric, synthetic fabric and leather fabric, and more specifically cotton fabric.

The writing ink composition according to the present disclosure has more specifically a viscosity of 3 to 10 mPa·s, and even more specifically of 3 to 7 mPa·s, measured at 20° C. with a Shell Cup #1 marketed by NORCROSS® Corporation. When the viscosity is less than 3 mPa·s, the pigment particles may settle more rapidly in the writing ink composition with a risk of ink leakage. Furthermore, when the viscosity is higher than 10 mPa·s, the flow rate of the writing ink composition is too low and any line was not written.

In an advantageous embodiment the writing ink composition according to the disclosure is intended for writing porous substrate (also named porous surfaces), more specifically writing fibrous substrate, in particular made, basically, of pressed, matted fibers, more specifically comprising cellulose fibers, more specifically selected in the group consisting of paper, printer paper and cardboard.

The present disclosure also concerns a method for preparing a writing ink composition according to the disclosure, comprising the steps of:
(i) under stirring, adding the at least one dye (c) to water (e),
(ii) under stirring, adding the at least one film-forming elastomeric polymer (a) to the mixture obtained in step (i),
(iii) under stirring, adding the at least one polyether-modified polysiloxane (b), the at least one pigment (d), and the optional at least one plasticizer, to the mixture obtained in step (ii), and
(iv) under stirring, adding the optional additives to the mixture obtained in step (iii).

The film-forming elastomeric polymer (a), polyether-modified polysiloxane (b), dye(s) (c), pigment (d), water (e), as well as the optional plasticizer and additive(s), are as defined above for the writing ink composition according to the disclosure.

During steps (i), (ii), (iii), and (iv), the ink ingredients are mixed under stirring at room temperature (20° C.), more specifically at a stirring speed ranging from 200 to 700 rpm, and even more specifically at a stirring speed of 500 rpm.

The writing ink composition obtained in steps (i), (ii), (iii), and (iv), can be homogenized during a certain period of time ranging from 3 to 20 minutes, and more specifically from 5 to 10 minutes.

The present disclosure also concerns a writing instrument, more specifically a handheld writing instrument, in particular a pen such as a felt-pen, a highlighter, a marker, and more specifically it is a writing felt-pen, a coloring felt-pen, a highlighter, containing a writing ink composition according to the disclosure. More specifically the writing instrument is not a ball pen.

More specifically, the writing ink composition according to the disclosure is not a ball pen ink and the writing ink composition of the disclosure has a low viscosity, in particular a viscosity ranging from 3 to 10 mPa·s,

More specifically, the writing instrument according to the present disclosure comprises an eraser, in particular located on the cap or on the non-writing end of the writing instrument. More particularly, the eraser consists of ethylene-propylene-diene monomer (EPDM) rubber, Vulcanized Thermoplastic Elastomer (TPV) which is a blend of ethylene-propylene-diene monomer (EPDM) rubber and polypropylene (PP), ethylene-propylene rubber (EPR), poly(styrene-butadiene-styrene) (SBS), styrene ethylene butylene styrene (SEBS), natural rubber (NR), polyisoprene (IR), polyvinyl chloride, styrene-based thermoplastic elastomers including styrene-butadiene-styrene (SBS), styrene-ethylene-butylene-styrene (SEBS), styrene-ethylene-propylene-styrene (SEPS), styrene-ethylene-ethylene-propylene-styrene (SEEPS), polyether based polyurethane (PTU), and mixtures thereof.

According to a preferred embodiment, the writing instrument according to the present disclosure comprises:
an axial barrel containing a writing ink composition according to the disclosure, and
a pen body which delivers the writing ink composition stored in the axial barrel.

Another object of the present disclosure is a method for writing on a writing porous substrate, comprising the step of applying a writing ink composition according to the disclosure to a writing porous substrate, more specifically fibrous, more specifically comprising cellulose fibers, and even more specifically chosen in the group consisting of paper, printer paper or cardboard. The method for writing on a writing porous substrate may further comprise the step of changing the initial color (first color) of the writing into another color (second color) by peeling, more specifically by peeling the writing mark with a finger or with a friction body wherein the friction body is an eraser or a tissue, more specifically the first and second colors being different from each other.

Finally, another object of the present disclosure is a writing porous substrate, more specifically fibrous, more specifically comprising cellulose fibers, coated with a writing ink composition according to the present disclosure, wherein the writing substrate is more specifically chosen in the group consisting of paper, printer paper or cardboard.

In addition to the foregoing, the disclosure also comprises other provisions which will emerge from the additional description which follows, which relates to the preparation of writing ink compositions according to the present disclosure and comparative examples.

### EXAMPLES

### Example 1: Preparation of a Writing Ink Composition According to the Invention

A writing ink composition according to the present invention comprising the ink ingredients of Table 1 was prepared.

TABLE 1

| | | Composition |
|---|---|---|
| | | 1 according |
| | | to the |
| | | invention |
| Trade name | Chemical name | (% by weight) |
| Water | | 45.90% |
| Esacote | Anionic dispersion of | 40% (ie 14% of |
| SW3 ® | polyurethane (dry extract: | polyurethane) |
| | 35 wt. % and about | |
| | 65% of water | |
| Belsil ® | INCI name: Bis-PEG-15- | 2% |
| DMC6038 | Methyl Ether Dimethicone | |
| Glycerin | Glycerin | 7.5% |
| APE FREE | Pigment dispersion | 3.50% |
| BL 15:3 Disp | (water-based dispersion | (ie 1.47% of |
| BPD 0015 | comprising about | pigment) |
| | 42 wt. % pigment) | |
| Sanolin ® | Acid Red 52 | 0.60% |
| Rhodamine B02 | | |
| Acticide PHE | Phenoxyethanol | 0.50% |
| Total | | 100% |

For a preparation of 1 kg, 459 g of water was introduced at room temperature in a dissolver DISPERMAT® LC75 (dissolver disc Ø 60 mm), and 6 g of Sanolin® Rhodamine B02 (Clariant) were added under agitation (stirring speed: 500 rpm). Then, 400 g of Esacote SW3® (Lamberti) were added at the same stirring speed. The % of polyurethane in Esacote SW3® (Lamberti) represents 35 wt. % (dry extract), and thus the % of polyurethane in the final ink composition is of 14% by weight. After 5 minutes, 75 g of glycerin were introduced. After 5 minutes under the same stirring speed, 20 g of Belsil® DMC6038 (Wacker) were added. After 5 minutes under the same stirring speed, 35 g of a blue pigmented dispersion APE FREE BL 15:3 Disp BPD 0015 (SunChemical) were added. The mixture was stirred for 5 minutes more. Then, 5 g of Acticide PHE were added, and the mixture was stirred for 5 minutes more to obtain the final writing ink com position.

The viscosity of the writing ink composition was measured at 20° C. with a Shell Cup #1 marketed by NORCROSS® Corporation, according to the following procedure:
1. Dip the Shell Cup in the writing ink composition until the cup is completely filled with ink composition.
2. Take the Shell Cup out of the fluid and start the timer simultaneously.
3. Stop the timer as soon as the fluid does not flow out any more. The time displayed on timer is reported as the Shell Cup viscosity at 20° C. of the fluid.
4. Clean and dry the Shell Cup.
5. Repeat steps 1 to 5 with the same fluid two times.
6. Report the average viscosity of the three measures.
7. Store the Shell Cup at 20° C.

The viscosity of the writing ink composition of example 1 measured according to this procedure was: 5.9 mPa·s.

### Example 2: Preparation of a Comparative Writing Ink Composition 2

A comparative writing ink composition comprising the ink ingredients of Table 2 was prepared.

TABLE 2

| | | Comparative |
|---|---|---|
| | | ink |
| | | composition 2 |
| Trade name | Chemical name | (% by weight) |
| Water | | 38.40% |
| Europrene ® | Anionic dispersion of | 45% (ie 18.45 |
| Latice 084 | styrene butadiene | % of SBR) |
| | copolymer (SBR) | |
| | (dry extract: 41 wt. %) | |
| Belsil ® | INCI name: Bis-PEG-15- | 2% |
| DMC6038 | Methyl Ether Dimethicone | |
| Glycerin | Glycerine | 10% |
| APE FREE | Pigment dispersion | 3.50% |
| BL 15:3 Disp | (water-based dispersion | (ie 1.47% of |
| BPD 0015 | comprising about | pigment) |
| | 42 wt. % pigment) | |
| Sanolin ® | Acid Red 52 | 0.60% |
| Rhodamine B02 | | |
| Acticide PHE | Phenoxyethanol | 0.50% |
| Total | | 100% |

For a preparation of 1 kg, 384 g of water were introduced at room temperature in a dissolver DISPERMAT® LC75 (dissolver disc Ø 60 mm), and 6 g of Sanolin® Rhodamine B02 (Clariant) were added under agitation (stirring speed: 500 rpm). Then, 450 g of Europrene Latice 084® (Versalis) were added at the same stirring speed. The % of SBR in Europrene Latice 084® (Versalis) represents 41 wt. % (dry extract), and thus the % of SBR in the final ink composition is of 18.45% by weight. After 5 minutes, 100 g of glycerin were introduced. After 5 minutes under the same stirring speed, 20 g of Belsil® DMC6038 (Wacker) were added. After 5 minutes under the same stirring speed, 35 g of a blue pigmented dispersion APE FREE BL 15:3 Disp BPD 0015 (SunChemical) were added. The mixture was stirred for 5 minutes more. Then, 5 g of Acticide PHE were added, and the mixture was stirred for 5 minutes more in order to obtain the final writing ink composition.

The viscosity of the writing ink composition measured at 20° C. with a Shell Cup #1 marketed by NORCROSS® Corporation was 4.6 mPa·s.

### Example 3: Preparation of a Comparative Writing Ink Composition 3

A comparative writing ink composition comprising the ink ingredients of Table 3 was prepared.

TABLE 3

| | | Comparative |
|---|---|---|
| | | ink |
| | | composition 3 |
| Trade name | Chemical name | (% by weight) |
| Water | | 45.90% |
| Esacote | Anionic dispersion | 40% (ie 14% of |
| SW3 ® | of polyurethane | polyurethane) |
| | (dry extract: 35 wt. %) | |
| PAT ® | Polyoxyethylene sorbitan | 2% |
| 662(Wurtz) | monolaurate | |
| Glycerin | Glycerine | 7.5% |
| APE FREE | Pigment dispersion | 3.5% |
| BL 15:3 Disp | (water-based dispersion | (ie 1.47% of |
| BPD 0015 | comprising about | pigment) |
| | 42 wt. % pigment) | |
| Sanolin ® | Acid Red 52 | 0.6% |
| Rhodamine B02 | | |
| Acticide PHE | Phenoxyethanol | 0.5% |
| Total | | 100% |

For a preparation of 1 kg, 459 g of water was introduced at room temperature in a dissolver DISPERMAT® LC75 (dissolver disc Ø 60 mm), and 6 g of Sanolin® Rhodamine B02 (Clariant) were added under agitation (stirring speed: 500 rpm). Then, 400 g of Esacote SW3® (Lamberti) were added at the same stirring speed. The % of polyurethane in Esacote SW3® (Lamberti) represents 35 wt. % (dry extract), and thus the % of polyurethane in the final ink composition is of 14% by weight. After 5 minutes, 75 g of glycerin were introduced. After 5 minutes under the same stirring speed, 20 g of PAT® 662(Wurtz) were added. After 5 minutes under the same stirring speed, 35 g of a blue pigmented dispersion APE FRE BL 15:3 Disp BPD 0015 (SunChemical) were added. The mixture was stirred for 5 minutes more. Then, 5 g of Acticide PHE were added, and the mixture was stirred for 5 minutes more to obtain the final writing ink com position.

The viscosity of the writing ink composition measured at 20° C. with a Shell Cup #1 marketed by NORCROSS® Corporation was 5.7 mPa·s.

### Example 4: Peelability Performances Of The Prepared Writing Ink Compositions 1-3

### Erasability Performance: Measurement of Peelability

The peelability (erasing efficiency of the first color) is the ability of the eraser to peel correctly the written mark of first color applied on a writing porous substrate (calligraph notebook: Calligraphe LIGNE 7000 (70g/m2, 210×297 mm, 80 pages, by Clairefontaine), evaluated by visual assessment according to the following method at 23° C. and 50% relative humidity. The erasability performance is part of the color-changing performances of the writing ink com position.

The color of the obtained written mark made on the writing porous substrate is called “color 1” and corresponds to the initial (first) color of the written mark (here color 1: blue). The written mark was then peeled (or rubbed) with an eraser, i.e. polyether based polyurethane (PTU), just after writing (around 10 seconds after writing), to peel the initial color of the written mark and allow it to change from initial color 1 (here color 1: blue) into a second color 2 (here color 2: pink). Hence, the initial color 1 (here color 1: blue) was removed by peeling with the eraser.

The method is as follows:

Loops were drawn with a pen on the writing porous substrate, and then peeled in one time back and forth.

The scoring (i.e. the peeling efficiency of color 1) is defined as follows:

10: Erasability by peeling of the first color 1 is very efficient (no remaining written mark of the initial color 1)—The color of the writing ink composition after applying on the writing porous substrate and after peeling corresponds to color 2.

5: The color of the writing ink composition after applying on the porous substrate and after peeling is not efficient (remaining written marks of the initial color 1 into the color 2).

0: Erasability by peeling of the first color 1 is not efficient—The color of the writing ink composition after applying on the writing porous substrate and after peeling is not efficient (significant residual written marks of the initial (first) color 1 into the color 2).

The results are indicated in Table 4 below.

TABLE 4
Comparison of the color-changing
performances of the writing ink composition
1 of the invention (example 1) with
the comparative writing ink compositions
2 and 3 (Comparative examples 2 and 3)

| | Color-changing |
|---|---|
| | of the initial |
| | color after |
| | peeling-Peeling |
| Writing ink | efficiency |
| compositions | of color 1 |
| writing ink | 10 |
| composition 1 | |
| (invention) | |
| Comparative | 5 |
| writing ink | |
| composition 2 | |
| Comparative | 0 |
| writing ink | |
| composition 3 | |

As shown in Table 4, the written marks of the writing ink composition 1 according to the invention (example 1) exhibit good results in terms of efficiency of the erasing by peeling (the initial color of the written mark was efficiently removed).

The written mark made, with the comparative writing ink compositions 2 and 3 of examples 2 and 3 cannot be peeled efficiently, in particular when compared with the written mark made with the writing composition of example 1 according to the invention, which can be peeled efficiently and easily. In particular, it should be also noted that even if the comparative composition 2 comprises more film-forming elastomeric polymer than composition 1 according to the invention, it can be less efficiently peeled than composition 1.

1. A writing ink composition comprising:
(a) at least one film-forming elastomeric polymer wherein the film-forming elastomeric polymer (a) is an homopolymer or copolymer of polyurethane,
(b) at least one polyether-modified polysiloxane,
(c) at least one dye,
(d) at least one pigment, and
(e) water
wherein the total content of the at least one dye (c) ranges from 0.1 to 10% by weight, relative to the total weight of the writing ink composition and the total amount of the pigment (d) ranges from 0.1 to 10% by weight, relative to the total weight of the writing ink composition.

2. The writing ink composition according to claim 1, wherein the homopolymer or copolymer of polyurethane (a) is selected from the group consisting of amphoteric polyurethanes, anionic polyurethanes, cationic polyurethanes, non-ionic polyurethanes, polyester-polyurethanes, polyether-polyurethanes and mixtures thereof.

3.-15. (cancelled)

16. The writing ink composition according to claim 1, wherein the homopolymer or copolymer of polyurethane (a) is an anionic polyurethane homopolymer.

17. The writing ink composition according to claim 1, wherein the homopolymer or copolymer of polyurethane (a) is in the form of an aqueous dispersion.

18. The writing ink composition according to claim 1, wherein the total solid content of the polyurethane (a) ranges from 8 to 25%, by weight relative to the total weight of the writing ink composition.

19. The writing ink composition according to claim 1, wherein the at least one polyether-modified polysiloxane (b) is non-ionic.

20. The writing ink composition according to claim 1, wherein the at least one polyether-modified polysiloxane (b) is a polyether-modified polydimethylsiloxane.

21. The writing ink composition according to claim 1, wherein the at least one polyether-modified polysiloxane (b) is a Bis-PEG 15-Methyl Ether Dimethicone.

22. The writing ink composition according to claim 1, wherein the total amount of the at least one polyether-modified polysiloxane (b) ranges from 0.5 to 5% by weight relative to the total weight of the writing ink composition.

23. The writing ink composition according to claim 1, wherein the at least one dye (c) is selected from the group consisting of direct dyes, acid dyes, food dyes, and mixtures thereof.

24. The writing ink composition according to claim 1, wherein the at least one pigment (d) is in the form of a pigment dispersion.

25. The writing ink composition according to claim 1, wherein the total amount of the pigment (d) ranges from 0.5 to 7% by weight, relative to the total weight of the writing ink composition.

26. The writing ink composition according to claim 1, wherein the total content of the at least one dye (c) ranges from 0.2 to 8%, relative to the total weight of the writing ink composition.

27. The writing ink composition according to claim 1, wherein the total amount of water (e) ranges from 10 to 80% by weight, relative to the total weight of the writing ink composition.

28. The writing ink composition according to claim 1, wherein the composition further comprises at least one additive.

29. The writing ink composition according to claim 1, wherein the writing ink composition is a peelable writing ink.

30. The writing ink composition according to claim 1, wherein the writing ink composition is a peelable color-changing writing ink.

31. A writing instrument containing a writing ink composition according to claim 1, wherein the writing instrument is a pen.

32. The writing instrument according to claim 31, wherein the writing instrument comprises an eraser.

33. A method for writing on a writing porous substrate, comprising a step of applying a writing ink composition according to claim 1, to a writing porous substrate.
